(19) United States
(12) Patent Application Publication
(10) Pub. No.: US 2026/0017084 A1
(43) Pub. Date: Jan. 15, 2026

(54) EFFICIENT COMMAND QUEUE ARCHITECTURE FOR FAULTLESS BI-DIRECTIONAL COMMUNICATION

(71) Applicants: Rupin H. VAKHARWALA, Hillsboro, OR (US); Paras GOYAL, Folsom, CA (US); Karthik V. NARAYANAN, Chandler, AZ (US); Philip LANTZ, Cornelius, OR (US); Michael PRINKE, Aloha, OR (US); Nastaran HAJINAZAR, Santa Clara, CA (US); Raghunathan SRINIVASAN, Chandler, AZ (US)

(72) Inventors: Rupin H. VAKHARWALA, Hillsboro, OR (US); Paras GOYAL, Folsom, CA (US); Karthik V. NARAYANAN, Chandler, AZ (US); Philip LANTZ, Cornelius, OR (US); Michael PRINKE, Aloha, OR (US); Nastaran HAJINAZAR, Santa Clara, CA (US); Raghunathan SRINIVASAN, Chandler, AZ (US)

(21) Appl. No.: 19/338,780

(22) Filed: Sep. 24, 2025

Related U.S. Application Data
(60) Provisional application No. 63/704,189, filed on Oct. 7, 2024.

(51) Int. Cl. G06F 9/455

(52) U.S. Cl. CPC G06F 9/45558; G06F 2009/45583

(57) ABSTRACT

This disclosure describes systems, methods, and devices related to enhanced bi-directional communication. A device may receive a descriptor queue base address and queue size from a virtual machine monitor. The device may allocate a memory region twice the size of a standard descriptor queue. The device may pin memory pages for both a descriptor region and a completion address region. The device may validate descriptor submissions based on a predefined completion address range.

### CROSS-REFERENCE TO RELATED APPLICATION(S)

This application claims the benefit of U.S. Provisional Application No. 63/704,189, filed Oct. 7, 2024, the disclosure of which is incorporated herein by reference as if set forth in full.

### BACKGROUND

In today's rapidly evolving digital landscape, complex computing systems require efficient data transfer to handle increasing workloads and ensure seamless performance. As the demand for faster and more reliable communication between components grows, traditional methods often struggle to keep pace. There is a need for innovative solutions that enhance data transfer efficiency and reliability across these systems.

### BRIEF DESCRIPTION OF THE DRAWINGS

FIGS. 1-4 depict illustrative schematic diagrams for enhanced communication, in accordance with one or more example embodiments of the present disclosure.

FIG. 5 illustrates a flow diagram of a process for an enhanced communication system, in accordance with one or more example embodiments of the present disclosure.

FIG. 6 illustrates an embodiment of a block diagram for a computing system including a processor, in accordance with one or more example embodiments of the present disclosure.

FIG. 7 illustrates an example system, in accordance with one or more example embodiments of the present disclosure.

FIG. 8 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Virtual machine (VM) is a logical entity that is implemented over a hardware platform and operating system (OS). This allows multiple operating systems to run on a single physical machine, enhancing resource utilization. Each VM can operate independently of other VMs and yet utilize the same hardware resources. For example, a server can host both Windows and Linux VMs simultaneously, each running different applications. A virtual machine monitor (VMM) is virtualization software that creates and manages multiple VMs from a single physical host machine. The VMM acts as a bridge between the hardware and the VMs, ensuring efficient resource distribution. A VMM is responsible for monitoring, pooling, and allocating resourceslike CPU, memory, and storage—across all guest VMs. This ensures that each VM gets the necessary resources to function optimally, similar to how a hotel manager allocates rooms to guests. In other words, virtual machines operate over a hardware platform and OS, managed by a VMM, where descriptors are submitted from an operating system to hardware to take care of specific tasks, but direct submission can lead to page faults if memory addresses are not in memory. When descriptors are submitted by a guest operating system, the device tries to locate and translate memory locations, and if it cannot find specific memory locations during translation, it will encounter a page fault that requires complex resolution processes.

A Descriptor is a pre-defined hardware/software construct with a payload and completion address. Descriptors are crucial for efficient communication between software and hardware. Hardware/device exposes multiple descriptor queues, to which software submits/queues these descriptors to accomplish specific tasks. These tasks can range from simple data transfers to complex computational operations. These tasks or commands can be to invalidate caches, to submit work or anything device-specific. For instance, a descriptor might be used to clear cache memory to ensure data consistency. The ‘Completion Address’ submitted as part of the descriptor is used to synchronize command completions with hardware, and to indicate completions to the submitter. This synchronization is vital for maintaining system stability and performance, much like a project manager tracking task completions.

Hardware/devices that support direct submission of descriptors from Guest OS cannot do so without accommodating for page faults. Page faults occur when the system tries to access data not currently in physical memory, leading to delays. Page faults occur when the system attempts to access data that isn't currently loaded in physical memory, causing delays as the data is retrieved from storage.

For queued descriptors, a descriptor fetch or pre-fetch could result in a page-fault if the address is not in memory. This can cause significant slowdowns, similar to waiting for a book to be retrieved from a distant library. In addition, for a descriptor carrying a completion address (CA), the hardware could potentially encounter a page-fault during completion status write, if the completion address is not in memory. Such faults can disrupt the flow of operations, akin to a traffic jam on a busy highway. This is bad for performance and increases implementation complexity. Complexity arises as additional mechanisms are needed to handle these faults efficiently. The problem is exacerbated for implementations where a VMM does memory overcommitment, as the descriptor memory pages could be paged-out. Overcommitment can lead to resource shortages, much like overbooking a flight.

This disclosure addresses the problem by avoiding costly page-faults by making sure the descriptor address ranges, and the completion address ranges are pinned before the descriptor is submitted. This problem statement applies to various architectures.

In theory, there could be two possible solutions to this problem.
1. A VMM could pin all the guest memory pages.
2. By implementing a software interface between guest VMs and a VMM, the guest OS software can inform the VMM of the list of addresses that needs to be pinned every time a descriptor needs to be submitted.
1. A. Pinning memory limits the number of VMs that can be powered on and can place CPU and memory resources non-optimally over time.
B. VMMs implementing memory overcommit cannot pin all the guest memory pages.
2. To ensure consistent operation across various guest VMs (such as Linux and Windows), the software interface for communicating which memory addresses need to be pinned should be standardized and mutually agreed upon. and different implementations of VMM (VMware ESXi, Hyper-V, QEMU, Xen etc.). This will require an industry standards body agreement which does not exist today. Additionally, the software interfaces adds latency for queue setup and for every descriptor submission to ensure the memory addresses are pinned. This impacts overall performance.
3. If such an industry standard is developed, it would allow a malicious/greedy VM to request that all its memory be pinned. Hence this approach will not be acceptable to VMMs.

Pinning means locking memory areas in physical RAM, preventing them from being swapped out to disk. This ensures that when the hardware accesses these addresses, the data is immediately available in memory, avoiding delays caused by page-faults. Page-faults occur when the system tries to access data not currently in physical memory, leading to performance slowdowns. By pinning the necessary memory, the system maintains efficient and uninterrupted processing.

Example embodiments of the present disclosure relate to systems, methods, and devices for command queue architecture that allows Guest software (SW) and hardware (HW) to communicate (bi-directional) without page-faults from Host SW.

In one or more embodiments, a novel queue architecture for software to submit descriptors to the descriptor queues is presented in this disclosure.

In one or more embodiments, an enhanced communication system may facilitate a novel mechanism ensuring the hardware does not encounter page-faults either during descriptor fetch/pre-fetch or during the status write to the completion address in the descriptor.

In one or more embodiments, an enhanced communication system may constrain descriptors and associated completions to be in a memory range that VMM can easily infer and pin. Constraining descriptors and their associated completions to specific memory ranges allows the VMM to manage and pin these areas in physical memory. By defining these memory regions, the VMM can efficiently lock them in RAM, preventing them from being swapped out and avoiding page-faults. This ensures that when the hardware accesses these addresses, the data is immediately available, maintaining efficient and uninterrupted processing. This approach optimizes performance and stability in virtualized environments by allowing the VMM to effectively monitor and control these critical memory areas.

In one or more embodiments, an enhanced communication system may avoid any page-faults that could potentially be encountered during descriptor fetch/pre-fetch. Additionally, when completion addresses are used as part of descriptor submission, this system will ensure that no page-faults are encountered when the hardware/device writes the completion status in the address.

In one or more embodiments, an enhanced communication system may enable new use-cases where a VMM could implement memory overcommits.

In one or more embodiments, an enhanced communication system may be described architecturally in the hardware and device specifications, enabling case of implementation. Hardware and software implementing this system will be performant as it pre-pins the associated memory page ranges.

In one or more embodiments, an enhanced communication system may comprise one or more components, which may include one or more of: apparatus, device, and/or other types of hardware. At its most basic configuration, the system includes one or more processors, and/or memory, and/or instructions. The processor(s) may be implemented using general-purpose microprocessors, and/or digital signal processors (DSPs), and/or field-programmable gate arrays (FPGAs), and/or other suitable computational entities capable of performing calculations or manipulations of information. The memory may include RAM, and/or ROM, and/or flash memory, and/or other storage media suitable for storing instructions and/or data necessary for system operation. These components, individually or in combination, enable the execution of processes that facilitate communication and/or functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

This disclosure generally relates to systems and methods for data processing and, more particularly, to efficient command queue architecture for faultless bi-directional communication.

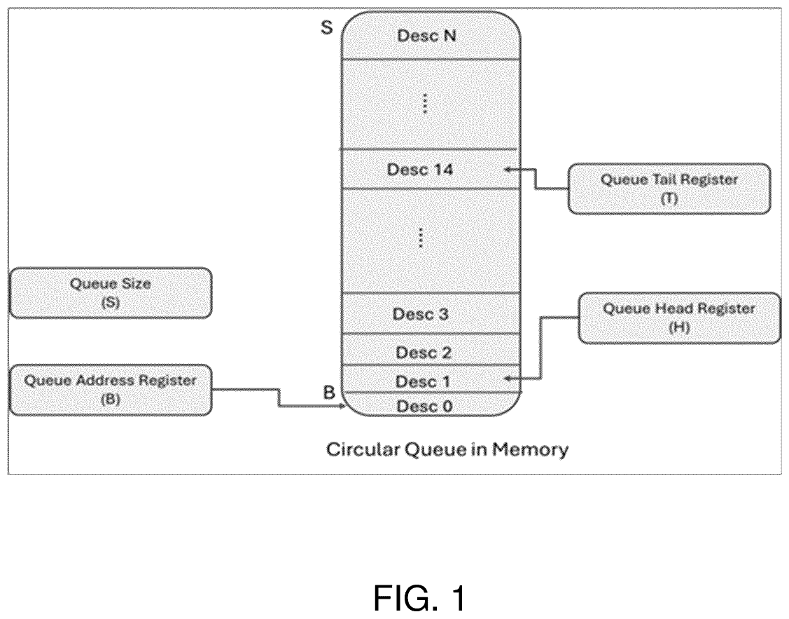

FIGS. 1-4 depict illustrative schematic diagrams for enhanced communication, in accordance with one or more example embodiments of the present disclosure.

A device or hardware implements one or more physical descriptor queues. Location of these queues are described by specific Control Registers implemented in the device/hardware. These queues are memory mapped into the guest VM to allow the guest OS software to submit descriptors directly to the device/hardware queues.

A guest OS is an operating system that runs within a virtual machine on a host system. It operates as if it were running on its own physical hardware, but it shares the underlying physical resources with other virtual machines. The guest OS is managed by a VMM or hypervisor, which allocates resources like CPU, memory, and storage to ensure each virtual machine functions independently.

These queues are circular queues in memory and are described by the following registers.
Queue Address Register: Software programs this register to configure the base physical address of the contiguous memory region hosting the queue.
Queue Size: Size of the contiguous memory region.
Queue Head Register: This register points to the descriptor in the queue that the device or hardware will process next. This is incremented by device or hardware after fetching a valid descriptor from the queue.
Queue Tail Register: This register points to the descriptor in the queue to be written next by software. Software increments this register after writing one or more descriptors in the queue.

Circular Queues are data structures that use a contiguous block of memory to store descriptors. The circular nature allows for efficient use of memory by wrapping around when the end of the queue is reached.

FIG. 1 shows the different registers described above and how the descriptors are submitted to a circular queue in memory.

Software uses descriptors to submit different types of commands to the hardware. They can be cache invalidation, work submission, or device-specific commands. These descriptors also carry ‘Completion Address’ to synchronize command completions with hardware. Hardware implementations describe support for these descriptors through their Capability Registers.

In one or more embodiments, a specialized circular queue architecture is implemented for efficient descriptor management in virtualized computing environments. The circular queue comprises a base address register, a size register, and two critical pointers: a head pointer and a tail pointer. The head pointer indicates the location where new descriptors are added to the queue, while the tail pointer identifies the next descriptor to be processed. Unlike traditional queue implementations, this embodiment allocates a memory region twice the standard size, with the first half dedicated to descriptor storage and the second half reserved for completion addresses. The circular nature of the queue allows for continuous, efficient descriptor submission and processing, with the head and tail pointers dynamically moving to ensure optimal utilization of the queue's memory space. By constraining the completion addresses to a predefined region and enabling automatic memory page pinning, the circular queue architecture provides a robust mechanism for reducing page faults and improving performance in hardware-software communication across virtualized platforms.

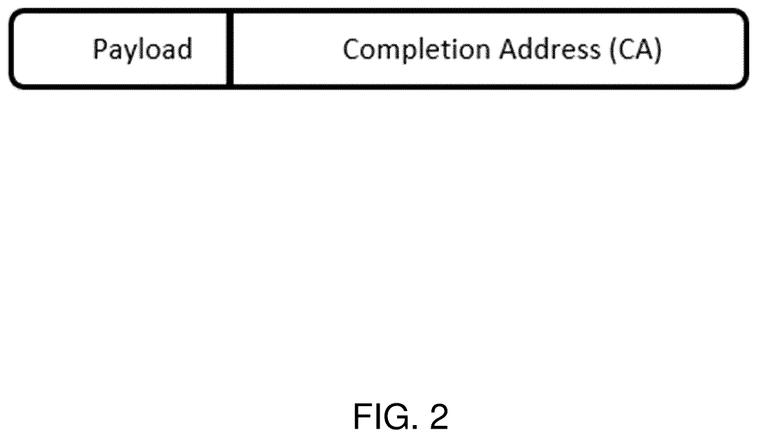

FIG. 2 shows an example descriptor. The descriptor consists of descriptor specific payload followed by an optional Completion Address.

Completion Address: Completion Address is used by the device/hardware to perform completion status write. Software provides the Completion Address in the descriptor.

When the hardware fetches the descriptor, it uses the Guest Physical Address (GPA) and when it writes the completion status it uses the completion address which is also GPA. When the descriptor is fetched or when the completion status write is performed by the hardware, if there is no valid mapping for this GPA->Host Physical Address (HPA), it will result in a fault thereby failing the descriptor operation or resort to other expensive mechanisms to fix these faults. This leads to implementation complexity, increases operational latency, and drop in performance. The occurrences of these faults increase when the Host or VMM implements memory over-commit, as pages could be swapped out and the GPA->HPA mappings would no longer be valid.

To solve this problem, this disclosure proposes ‘Implicit’ addresses. The mechanism of how these address mappings are determined and pinned is described in the subsequent sections.

In a different embodiment of this disclosure, the descriptors submitted by the guest OS could use Guest Virtual Addresses (GVA) or Guest IO Virtual Addresses (GIOVA), as long as mechanisms are implemented to guarantee the associated GVA->GPA->HPA or GIOVA->GPA->HPA mappings are pinned and does not page fault.

### Descriptor Queue and Completion Address Range Setup

When the Guest OS initializes the Descriptor Queue, it needs to program multiple registers. These registers are described above, and they are the Queue Address, Size, Head and Tail registers. The Guest OS programs these registers with GPA.

When the Guest OS allocates memory for the descriptor queue, it allocates twice the amount of memory as needed for the queue. The additional memory is for the completion address range. This memory is allocated contiguously in the GPA address space and is 4K aligned.

$$Total Memory Allocated = 2 * Descriptor Queue Size ( S ) .$$

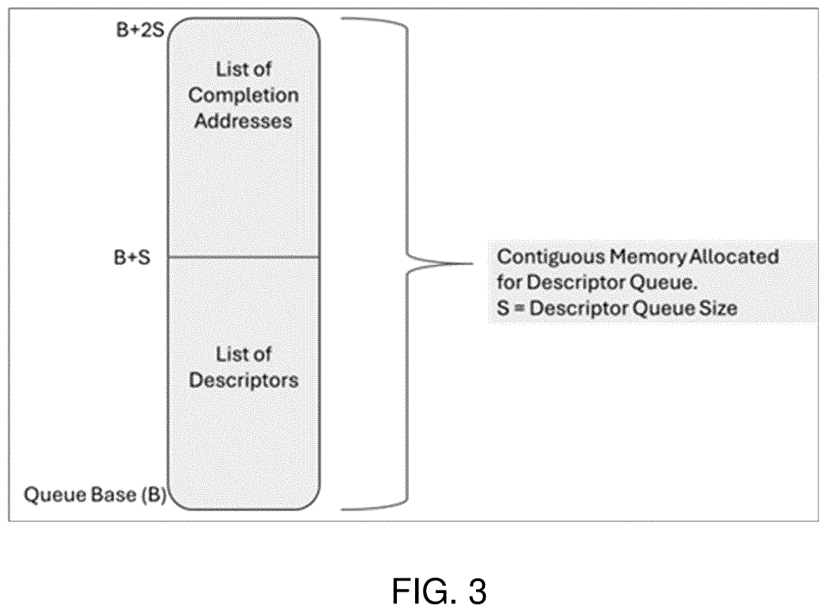

### FIG. 3: Contiguous Memory Allocated by Guest OS for Descriptor Queue

Hardware/device capability registers advertise the descriptor size and completion address size, for each descriptor queue it supports.

To describe the operation, the terminology below may be used. Refer to FIG. 3.

Let Queue Base Address=B.

Let Queue Size=S.

Software implements a circular queue in the memory range (B to B+S) for the descriptor queue.

Software uses the memory range (B to B+S) for the descriptors it is submitting to the queue. Software writes the descriptors to be submitted into this memory range.

Software uses the memory range (B+S to B+2S) for the list of Completion Addresses to use. Software keeps track of the list of free Completion Addresses it uses for descriptor submission.

Software builds the descriptor and submits to the descriptor queue using the following steps.

Payload for the descriptor is created.

Picks a free completion address in the region (B+S to B+2S−1) to be used for the descriptor.

Builds the descriptor with the payload from Step 1 and Completion Address from Step 2.

Writes the descriptor in the descriptor queue where the Queue Tail Register points to.

In a different embodiment the descriptor size and completion size may be different and hence the amount of memory used for descriptors and completion addresses can be different.

Pinning of memory associated with the Descriptor Queue and Completion Address range:

The guest OS setups up the descriptor queue as described in the above section. Once memory is allocated, the guest OS programs the memory mapped registers—Queue Address Register and Queue Size. The Queue Address Register is programmed with Queue Base Address (B). And the Queue Size is programmed with S (for example it is 4K).

The Host/VMM maps the Queue related registers as read-only for the Guest. When the Guest OS writes to these registers it traps into the Host/VMM. The Host/VMM uses the information being written by the Guest into the Queue Address Register and Queue Size to determine the list of memory pages it needs to pin.

Memory pages to pin=GPA->HPA ranges for B to B+2S.

The list of memory pages determined above will be pinned by the Host/VMM. This guarantees that when the guest OS submits a descriptor, the valid addresses are pinned a-priori avoiding costly page-faults. By doing this, it improves the locality of address references, leading to better performance. Note that the memory being pinned is contiguous in GPA space but can be disjoint/fragmented in the HPA space.

Handling faults and determining if a Completion Address is in the valid pinned address range:

When a descriptor is fetched by the hardware/device, opcode checks, reserved bit violation checks, and additional checks are performed by the hardware/device to determine if the descriptor is valid or not. If invalid, a bad descriptor fault is returned to the submitter.

In one or more embodiments, an enhanced communication system may facilitate another check to determine if the Completion Address is in the valid pinned address range or not. To determine this, the hardware uses the Queue Base Address and Queue Size to compute the valid completion address range. As long as the completion address is within the completion address range, the hardware considers it as a valid address. Else, the descriptor is dropped by hardware and a bad descriptor fault is returned to the submitter.

Completion Address (CA) is valid if it is in the range of: B+S<=CA<=B+2S−Completion_size.

Different mechanisms exist to report the descriptor faults. Hardware/device can use a pinned dedicated host queue to report the faulting descriptor and other error codes to the submitter. These mechanisms are outside the scope of this disclosure.

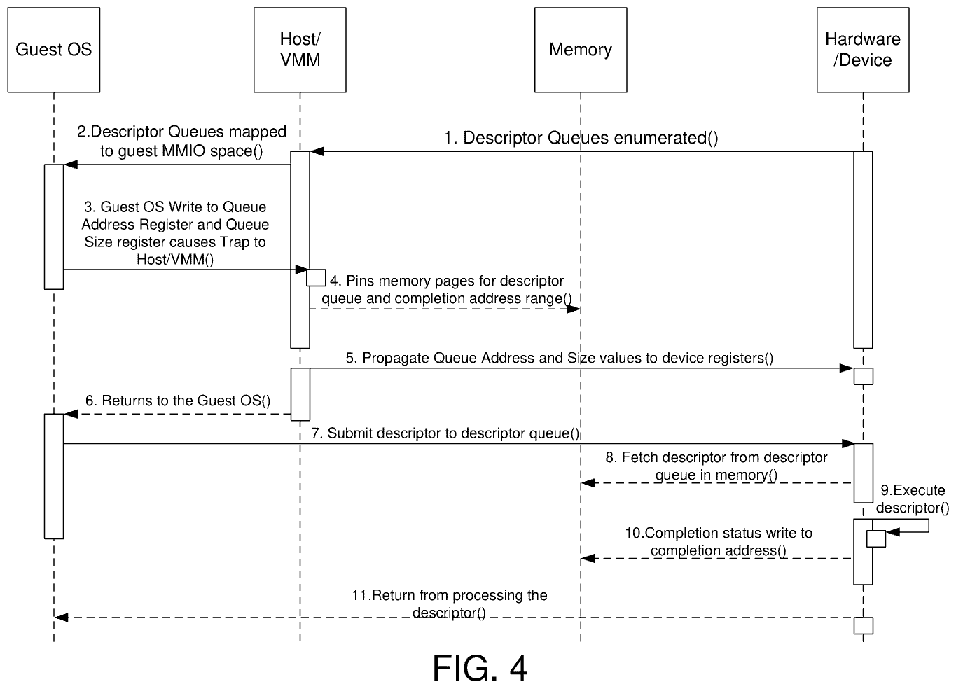

Sequence Diagram in FIG. 4.
1. Enumeration of Physical Device Descriptor Queue: The Virtual Machine Monitor (VMM) begins by enumerating the physical device descriptor queue.
2. Mapping to Guest MMIO Space: The Guest Operating System (OS) maps these descriptor queues into its Memory-Mapped I/O (MMIO) space.
3. Configuration of Queue Registers: The Guest OS configures the Queue Address and Queue Size registers. Writing to these registers triggers a trap, allowing the Host/VMM to gain control.
4. Memory Pinning by Host/VMM: The Host/VMM calculates the necessary pages to pin based on the Queue Address and Size registers. It pins the memory pages for both the descriptor queue and the completion address range.
5. Writing to Physical Device Registers: The Host/VMM writes the Queue Address and Queue Size values into the physical device registers.
6. Completion of Initial Setup: The sequence of operations initiated by the Guest OS is now complete.
7. Command Submission by Guest OS: The Guest OS initiates command execution by submitting a descriptor to the device descriptor queue.
8. Descriptor Fetching by Device: The device fetches the descriptor from the device descriptor queue in memory. With pinned memory pages, no faults occur.
9. Command Execution: The device executes the command specified in the descriptor.
10. Writing Completion Status: The device writes the Completion Status to the completion address provided during submission. Again, pinned memory pages prevent any faults.
11. Completion of Command Submission: The sequence of operations for command submission initiated by the Guest OS is now complete.

In one or more embodiments, a method, device, or system is disclosed for managing descriptor queues within a virtualized environment. For example, this method, device, or system involves the allocation of a contiguous memory region designated for a descriptor queue and a completion address range within a guest virtual machine (VM). Queue-related registers are programmed to define the base address and size of the descriptor queue. The host or virtual machine monitor (VMM) is responsible for pinning the memory pages associated with the descriptor queue and completion address range, thereby preventing page faults during descriptor fetch and completion status write operations. It is ensured that completion addresses used in descriptors remain within a valid pinned address range, thereby avoiding descriptor faults.

In one or more embodiments, a method, device, or system is described for managing descriptor queues in a virtualized environment. This method, device, or system includes a guest VM configured to allocate memory for descriptor queues and completion addresses, and to program queue-related registers with Guest Physical Address (GPA). The host or VMM is configured to trap writes to queue-related registers, determine the memory pages to pin, and pin these pages to prevent page faults. Additionally, a hardware device is configured to fetch descriptors from the queue, validate completion addresses against a pinned address range, and return faults for invalid descriptors.

In one or more embodiments, a method, device, or system is provided for submitting descriptors within a virtualized environment. This method, device, or system involves creating a payload for a descriptor within a guest VM and selecting a free completion address from a pre-allocated contiguous completion address range. A descriptor is then built with the payload and selected completion address and subsequently written to a circular queue in memory at a location indicated by the queue tail register.

In one or more embodiments, a method, device, or system is disclosed for validating completion addresses within a descriptor queue. For example, a hardware device is utilized to compute a valid completion address range based on the queue base address and queue size. It is then checked whether a completion address in a descriptor falls within the computed valid range. Descriptors with completion addresses outside the valid range are dropped, and a bad descriptor fault is returned.

In one or more embodiments, a method, device, or system is described for preventing page faults during descriptor queue operations. This method, device, or system includes a guest VM configured to allocate memory for descriptor queues and completion addresses, and to program queue-related registers with GPA. The host VMM is configured to pin memory pages associated with the descriptor queue and completion address range based on GPA. A hardware device is configured to fetch descriptors, validate completion addresses, and avoid page faults during descriptor operations.

In one or more embodiments, a method, device, or system is provided for handling descriptor faults within a virtualized environment. This method, device, or system involves performing checks on fetched descriptors to validate command, reserved bits, and completion address range. A bad descriptor fault is returned for invalid descriptors, and descriptor faults are reported using a dedicated host queue or other mechanisms.

In one or more embodiments, a method, device, or system is disclosed for enabling bi-directional communication between guest software and hardware within a virtualized environment. This method, device, or system allows hardware to send commands to guest software for processing without requiring a completion address field. The host or VMM pins only the descriptor portion of the queue to prevent page faults during hardware-to-software command submission.

In one or more embodiments, while embodiments describe software submitting commands to hardware through a descriptor queue, the underlying architectural principles can be extended to scenarios where hardware initiates communication with software. In such cases, the optional Completion Address field may not be required and the Host/VMM has to consider pinning the descriptor portion of the queue. This alternative implementation simplifies the communication mechanism by focusing on the essential descriptor transmission, allowing the Host/VMM to manage memory resources more efficiently by pinning only the descriptor region of the queue, thereby reducing memory overhead and potential page fault complexities when hardware generates commands for software processing.

It is understood that the above descriptions are for the purposes of illustration and are not meant to be limiting.

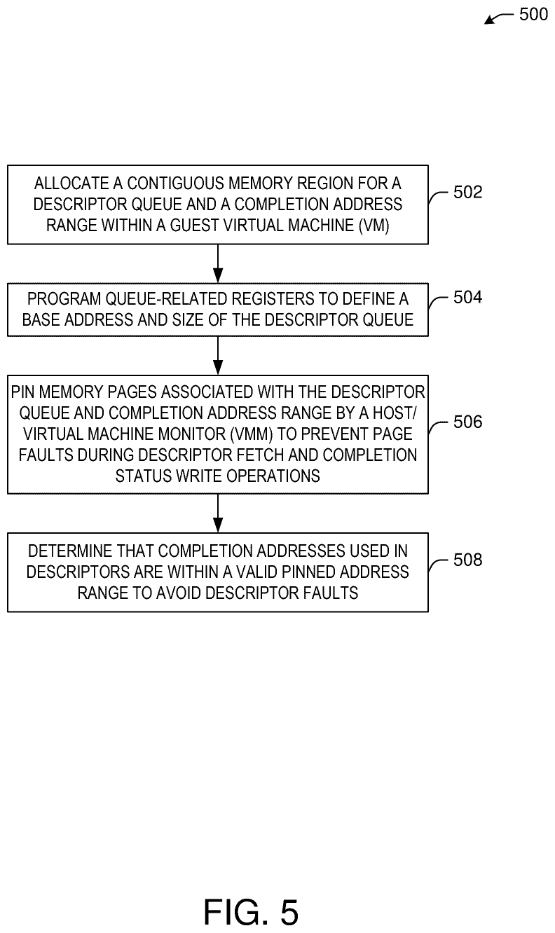

FIG. 5 illustrates a flow diagram of the illustrative process 500 for an enhanced communication system, in accordance with one or more example embodiments of the present disclosure.

At block 502, a device may allocate a contiguous memory region for a descriptor queue and a completion address range within a guest virtual machine (VM).

At block 504, the device may program queue-related registers to define a base address and size of the descriptor queue.

At block 506, the device may pin memory pages associated with the descriptor queue and completion address range by a host/virtual machine monitor (VMM) to prevent page faults during descriptor fetch and completion status write operations.

At block 508, the device may determine that completion addresses used in descriptors are within a valid pinned address range to avoid descriptor faults.

It is understood that the above descriptions are for the purposes of illustration and are not meant to be limiting.

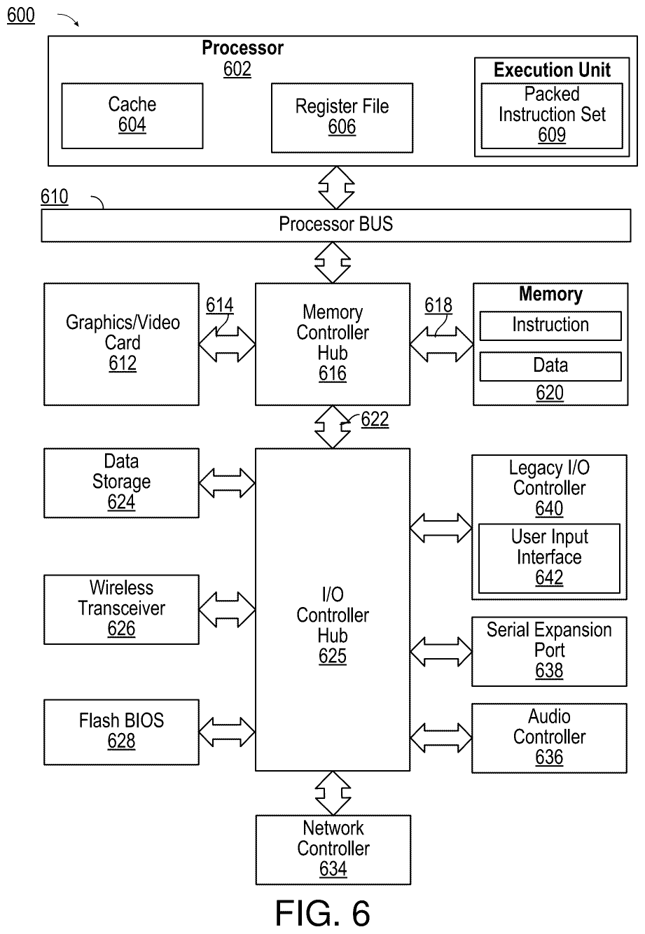

Turning to FIG. 6, a block diagram of an exemplary computer system formed with a processor that includes execution units to execute an instruction, where one or more of the interconnects implement one or more features in accordance with one embodiment of the present disclosure is illustrated. System 600 includes a component, such as a processor 602 to employ execution units including logic to perform algorithms for process data, in accordance with the present disclosure, such as in the embodiment described herein. In one embodiment, sample system 600 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 602 includes one or more execution units 608 to implement an algorithm that is to perform at least one instruction. One embodiment may be described in the context of a single processor desktop or server system, but alternative embodiments may be included in a multiprocessor system. System 600 is an example of a ‘hub’ system architecture. The computer system 600 includes a processor 602 to process data signals. The processor 602, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 602 is coupled to a processor bus 610 that transmits data signals between the processor 602 and other components in the system 600. The elements of system 600 (e.g. graphics accelerator 612, memory controller hub 616, memory 620, I/O controller hub 625, wireless transceiver 626, Flash BIOS 628, Network controller 634, Audio controller 636, Serial expansion port 638, I/O controller 640, etc.) perform their conventional functions that are well known to those familiar with the art.

In one embodiment, the processor 602 includes a Level 1 (L1) internal cache memory 604. Depending on the architecture, the processor 602 may have a single internal cache or multiple levels of internal caches. Other embodiments include a combination of both internal and external caches depending on the particular implementation and needs. Register file 606 is to store different types of data in various registers including integer registers, floating point registers, vector registers, banked registers, shadow registers, checkpoint registers, status registers, and instruction pointer register.

Execution unit 608, including logic to perform integer and floating point operations, also resides in the processor 602. The processor 602, in one embodiment, includes a microcode (ucode) ROM to store microcode, which when executed, is to perform algorithms for certain macroinstructions or handle complex scenarios. Here, microcode is potentially updateable to handle logic bugs/fixes for processor 602. For one embodiment, execution unit 608 includes logic to handle a packed instruction set 609. By including the packed instruction set 609 in the instruction set of a general-purpose processor 602, along with associated circuitry to execute the instructions, the operations used by many multimedia applications may be performed using packed data in a general-purpose processor 602. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 608 may also be used in micro controllers, embedded processors, graphics devices, DSPs, and other types of logic circuits. System 600 includes a memory 620. Memory 620 includes a dynamic random access memory (DRAM) device, a static random access memory (SRAM) device, flash memory device, or other memory device. Memory 620 stores instructions and/or data represented by data signals that are to be executed by the processor 602.

Note that any of the aforementioned features or aspects of the present disclosure and solutions may be utilized on one or more interconnect illustrated in FIG. 6. For example, an on-die interconnect (ODI), which is not shown, for coupling internal units of processor 602 implements one or more aspects of the embodiments described above. Or the embodiments may be associated with a processor bus 610 (e.g. other known high performance computing interconnect), a high bandwidth memory path 618 to memory 620, a point-to-point link to graphics accelerator 612 (e.g. a Peripheral Component Interconnect express (PCIe) compliant fabric), a controller hub interconnect 622, an I/O or other interconnect (e.g. USB, PCI, PCIe) for coupling the other illustrated components. Some examples of such components include the audio controller 636, firmware hub (flash BIOS) 628, wireless transceiver 626, data storage 624, legacy I/O controller 610 containing user input and keyboard interfaces 642, a serial expansion port 638 such as Universal Serial Bus (USB), and a network controller 634. The data storage device 624 can comprise a hard disk drive, a floppy disk drive, a CD-ROM device, a flash memory device, or other mass storage device.

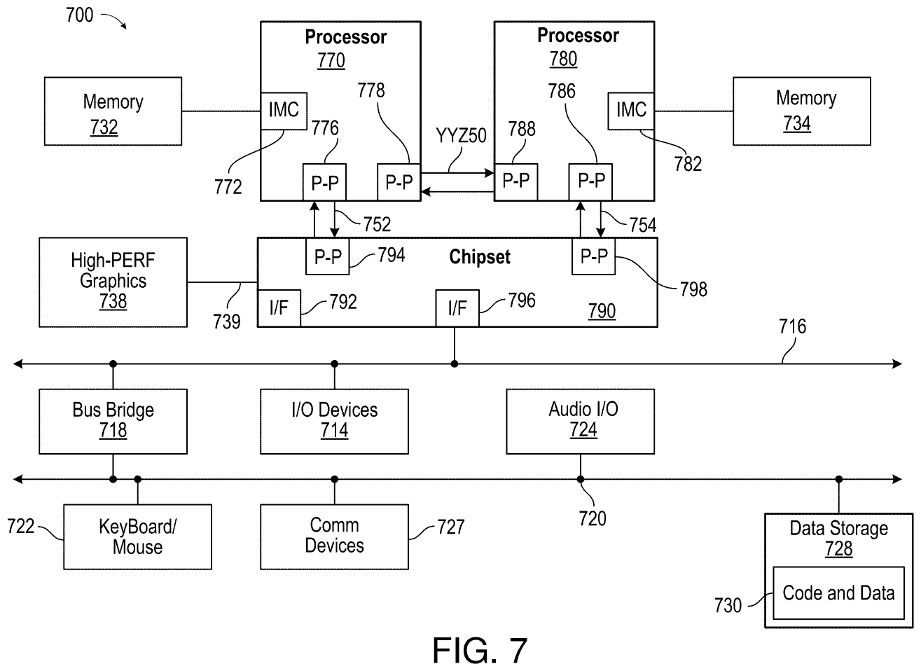

Referring now to FIG. 7, shown is a block diagram of a second system 700 in accordance with an embodiment of the present disclosure. As shown in FIG. 7, multiprocessor system 700 is a point-to-point interconnect system, and includes a first processor 770 and a second processor 780 coupled via a point-to-point interconnect 750. Each of processors 770 and 780 may be some version of a processor. In one embodiment, 752 and 754 are part of a serial, point-to-point coherent interconnect fabric, such as a high-performance architecture.

While shown with only two processors, 770, 780, it is to be understood that the scope of the present disclosure is not so limited. In other embodiments, one or more additional processors may be present in a given processor.

Processors 770 and 780 are shown including integrated memory controller units 772 and 782, respectively. Processor 770 also includes as part of its bus controller units point-to-point (P-P) interfaces 776 and 778; similarly, second processor 780 includes P-P interfaces 786 and 788. Processors 770, 780 may exchange information via a point-to-point (P-P) interface 750 using P-P interface circuits 778, 788. As shown in FIG. 7, IMCs 772 and 782 couple the processors to respective memories, namely a memory 732 and a memory 734, which may be portions of main memory locally attached to the respective processors.

Processors 770, 780 each exchange information with a chipset 790 via individual P-P interfaces 752, 754 using point to point interface circuits 776, 794, 786, 798. Chipset 790 also exchanges information with a high-performance graphics circuit 738 via an interface circuit 792 along a high-performance graphics interconnect 739.

A shared cache (not shown) may be included in either processor or outside of both processors; yet connected with the processors via P-P interconnect, such that either or both processors' local cache information may be stored in the shared cache if a processor is placed into a low power mode.

Chipset 790 may be coupled to a first bus 716 via an interface 796. In one embodiment, first bus 716 may be a Peripheral Component Interconnect (PCI) bus, or a bus such as a PCI Express bus or another third generation I/O interconnect bus, although the scope of the present disclosure is not so limited.

As shown in FIG. 7, various I/O devices 714 are coupled to first bus 716, along with a bus bridge 718 which couples first bus 716 to a second bus 720. In one embodiment, second bus 720 includes a low pin count (LPC) bus. Various devices are coupled to second bus 720 including, for example, a keyboard and/or mouse 722, communication devices 727 and a storage unit 728 such as a disk drive or other mass storage device which often includes instructions/code and data 730, in one embodiment. Further, an audio I/O 724 is shown coupled to second bus 720. Note that other architectures are possible, where the included components and interconnect architectures vary. For example, instead of the point-to-point architecture of FIG. 7, a system may implement a multi-drop bus or other such architecture.

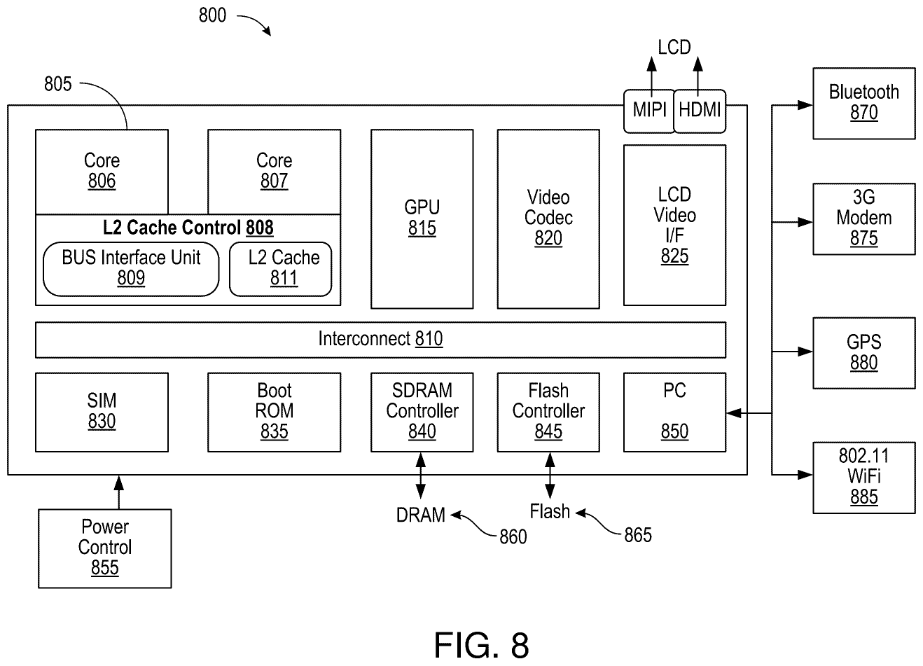

Turning next to FIG. 8, an embodiment of a system on-chip (SOC) design in accordance with the above disclosure is depicted. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 800 includes 2 cores—806 and 807. Similar to the discussion above, cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 811 to communicate with other parts of system 800. Interconnect 810 includes an on-chip interconnect, such as an IOSF, AMBA, or other interconnect discussed above, which potentially implements one or more aspects described herein.

Interface 810 provides communication channels to the other components, such as a Subscriber Identity Module (SIM) 830 to interface with a SIM card, a boot ROM 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control 850 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the embodiments described herein.

In addition, the system illustrates peripherals for communication, such as a Bluetooth module 870, 3G modem 875, GPS 885, and WiFi 885. Note as stated above, a UE includes a radio for communication. As a result, these peripheral communication modules are not all required. However, in the UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expressions “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a system for descriptor queue management in a virtualized environment, comprising a guest virtual machine (VM) configured to allocate memory for descriptor queues and completion addresses; a host virtual machine monitor (VMM) configured to trap writes to queue-related registers; and a hardware device configured to fetch descriptors from the queue, validate completion addresses against a predefined address range, and return false or invalid descriptors.

Example 2 may include the system of example 1, wherein the guest VM is further configured to program queue-related registers with a guest physical address.

Example 3 may include the system of example 1 and/or some other example herein, wherein the host VMM performs mapping using a predefined memory address range allocated for device communication.

Example 4 may include the system of example 1 and/or some other example herein, wherein the host VMM is further configured to determine memory pages to pin and pin the memory pages to prevent page faults.

Example 5 may include the system of example 1 and/or some other example herein, wherein the memory for descriptor queues and completion addresses are part of a contiguous memory region.

Example 6 may include the system of example 1 and/or some other example herein, wherein the guest VM sets specific register values that correspond to the memory location and size of the descriptor queue.

Example 7 may include the system of example 1 and/or some other example herein, wherein the trap triggered by writing to the queue-related registers is a software interrupt that transfers control to the VMM.

Example 8 may include the system of example 1 and/or some other example herein, wherein the hardware device verifies a successful configuration of the descriptor queue and readiness for data transmission.

Example 9 may include a device comprising processing circuitry, the device configured to receive a descriptor queue base address and queue size from a virtual machine monitor; allocate a memory region twice the size of a standard descriptor queue; pin memory pages for both a descriptor region and a completion address region; and validate descriptor submissions based on a predefined completion address range.

Example 10 may include the device of example 9, wherein the processing circuitry is further configured to expose read-only queue registers to a guest operating system.

Example 11 may include the device of example 9 and/or some other example herein, wherein the completion address region is automatically defined as a contiguous memory space from (base address+queue size) to (base address+2 * queue size).

Example 12 may include the device of example 9 and/or some other example herein, wherein the processing circuitry is further configured to prevent descriptor submissions with completion addresses outside a predefined region.

Example 13 may include the device of example 9 and/or some other example herein, wherein the processing circuitry generates an error response for invalid descriptor submissions.

Example 14 may include the device of example 9 and/or some other example herein, wherein the memory pages are pre-pinned to eliminate page faults during descriptor fetch and completion status write-back.

Example 15 may include the device of example 9 and/or some other example herein, further comprising an interface to trap and intervene when queue parameters are programmed.

Example 16 may include the device of example 9 and/or some other example herein, wherein the processing circuitry supports multiple virtualization platforms and operating systems.

Example 17 may include the device of example 9 and/or some other example herein, wherein the descriptor queue supports both software-to-hardware and hardware-to-software command submissions.

Example 18 may include a method for managing descriptor queues in a virtualized environment, comprising allocating a contiguous memory region for a descriptor queue and a completion address range within a guest virtual machine (VM); programming queue-related registers to define a base address and size of the descriptor queue; pinning memory pages associated with the descriptor queue and completion address range by a host/virtual machine monitor (VMM) to prevent page faults during descriptor fetch and completion status write operations; and determining that completion addresses used in descriptors are within a valid pinned address range to avoid descriptor faults.

Example 19 may include the method of example 18, further comprising verifying integrity of the queue-related registers after programming to ensure accurate descriptor operations.

Example 20 may include the method of example 18 and/or some other example herein, further comprising alerting the guest VM of any invalid completion addresses detected.

Example 21 may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Example 22 may include an apparatus comprising logic, modules, and/or circuitry to perform one or more elements of a method described in or related to any of examples 1-20, or any other method or process described herein.

Example 23 may include a method, technique, or process as described in or related to any of examples 1-20, or portions or parts thereof.

Example 24 may include an apparatus comprising: one or more processors and one or more computer readable media comprising instructions that, when executed by the one or more processors, cause the one or more processors to perform the method, techniques, or process as described in or related to any of examples 1-20, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted here in or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A system for descriptor queue management in a virtualized environment, comprising:
a guest virtual machine (VM) configured to allocate memory for descriptor queues and completion addresses;
a host virtual machine monitor (VMM) configured to trap writes to queue-related registers; and
a hardware device configured to:
fetch descriptors from the queue;
validate completion addresses against a predefined address range; and
return false or invalid descriptors.

2. The system of claim 1, wherein the guest VM is further configured to program queue-related registers with a guest physical address.

3. The system of claim 1, wherein the host VMM identifies the associated host physical address (HPA) mappings for the memory address range allocated for device communication.

4. The system of claim 1, wherein the host VMM is further configured to:
determine memory pages to pin; and
pin the memory pages to prevent page faults.

5. The system of claim 1, wherein the guest VM sets specific register values that correspond to the memory location and size of the descriptor queue.

6. The system of claim 1, wherein the trap triggered by writing to the queue-related registers is a software interrupt that transfers control to the VMM.

7. The system of claim 1, wherein the hardware device verifies a successful configuration of the descriptor queue and readiness for data transmission.

8. An apparatus comprising processing circuitry, the apparatus configured to:
receive a descriptor queue base address and queue size from a virtual machine monitor (VMM);
cause a VMM to allocate a memory region twice the size of a standard descriptor queue;
cause the VMM to pin memory pages for both a descriptor region and a completion address region; and
validate descriptor submissions based on a predefined completion address range.

9. The apparatus of claim 8, wherein the processing circuitry is further configured to expose read-only queue registers to a guest operating system.

10. The apparatus of claim 8, wherein the completion address region is automatically defined as a contiguous memory space from (base address+queue size) to (base address+2*queue size).

11. The apparatus of claim 8, wherein the processing circuitry is further configured to detect a bad descriptor and return an error.

12. The apparatus of claim 8, wherein the processing circuitry generates an error response for invalid descriptor submissions.

13. The apparatus of claim 8, wherein the memory pages are pre-pinned to eliminate page faults during descriptor fetch and completion status write-back.

14. The apparatus of claim 8, wherein the VMM comprises an interface to trap and intervene when queue parameters are programmed.

15. The apparatus of claim 8, wherein the processing circuitry supports multiple virtualization platforms and operating systems.

16. The apparatus of claim 8, wherein the descriptor queue supports both software-to-hardware and hardware-to-software command submissions.

17. A method for managing descriptor queues in a virtualized environment, comprising:
allocating a contiguous memory region for a descriptor queue and a completion address range within a guest virtual machine (VM);
programming queue-related registers to define a base address and size of the descriptor queue;
pinning memory pages associated with the descriptor queue and completion address range by a host or virtual machine monitor (VMM) to prevent page faults for descriptor fetch and completion status write operations; and
determining that completion addresses used in descriptors are within a valid pinned address range to avoid descriptor faults.

18. The method of claim 17, further comprising verifying integrity of the queue-related registers after programming to ensure accurate descriptor operations.

19. The method of claim 17, further comprising alerting the guest VM of any invalid completion addresses detected.

20. The method of claim 17, wherein the host or VMM comprises an interface configured to monitor access to the completion address range and intervene by generating an alert or error response in response to an attempt to write a completion status outside the pinned address range.
